(19) United States
(12) Patent Application Publication
(10) Pub. No.: US 2025/0164146 A1
(43) Pub. Date: May 22, 2025

(54) INSTANTANEOUS HEATING CUP AND WATER HEATER APPARATUS

(71) Applicant: Wuhu Midea Smart Kitchen Appliance Manufacturing Co., Ltd., Wuhu, (CN)

(72) Inventors: Shimei ZHANG, Wuhu (CN); Yongbing SHEN, Wuhu, (CN); Sensen XIN, Wuhu, (CN); Ruilun SONG, Wuhu, (CN); Liguo ZHOU, Wuhu, (CN)

(73) Assignee: Wuhu Midea Smart Kitchen Appliance Manufacturing Co., Ltd., Wuhu, (CN)

(21) Appl. No.: 19/031,784

(22) Filed: Jan. 18, 2025

Related U.S. Application Data
(63) Continuation of application No. PCT/CN2024/073339, filed on Jan. 19, 2024.

(30) Foreign Application Priority Data
Jan. 31, 2023 (CN) 202320205840.6

(51) Int. Cl. F24H 1/10; F24H 15/215; F24H 15/219; F24H 15/238; F24H 15/407

(52) U.S. Cl. CPC F24H 1/101; F24H 15/215; F24H 15/219; F24H 15/238; F24H 15/407

(57) ABSTRACT

An instantaneous heating cup and a water heater apparatus provided with the instantaneous heating cup are provided. The instantaneous heating cup includes a cup body, a water inlet pipe, a water outlet pipe, and a heating member. The cup body is configured with a heating zone and a mixing zone communicating with the heating zone. The water inlet pipe is connected to the cup body. The water inlet pipe has a water inlet communicating with the heating zone. The water outlet pipe is connected to the cup body. The water outlet pipe has a water outlet communicating with the mixing zone and the water outlet is arranged to incline towards the mixing zone. The heating member is arranged in the heating zone and is configured to heat water glowing through the heating zone.

### CROSS REFERENCE TO RELATED APPLICATIONS

The present application is a continuation application of International Patent Application No. PCT/CN2024/073339, filed on Jan. 19, 2024, which disclosure claims priority to Chinese Patent Application No. 202320205840.6, filed on Jan. 31, 2023, the entire contents of which are incorporated herein by reference.

### TECHNICAL FIELD

The present disclosure relates to the technical field of water heater apparatus, in particular, to an instantaneous heating cup and a water heater apparatus.

### BACKGROUND

An instantaneous heating cup is a core component of the instantaneous water heater apparatus. The instantaneous heating cup generally includes a cup body and a heating member arranged inside the cup body. To achieve instantaneous heating, in the production design, the volume of the cup body should be small, at the same time, the heating power and power density of the heating member should be large.

In the related art, the instantaneous heating cup usually adopts the form of water inflow from the bottom and water outflow from the top. Due to the thermal inertia of the heating member and the short distance between the bottom and the top of the heating cup, after the water flow enters the heating cup, it will quickly outflow from the top, which leads to the contact time of the water flow with the heating member being short, and the contact area also being small. Additionally, as the heating member has a high heat density, the heat of the heating member cannot be effectively conducted into the water, resulting in a high failure rate and a short service life. Moreover, this will also result in the water stoppage and the rise of the temperature, where the water temperature suddenly increases during short-term reuse, leading to unstable outlet water temperature and affecting the user experience.

### SUMMARY

The main purpose of the present disclosure is to provide an instantaneous heating cup.

To realize the above purpose, in a first aspect, some embodiments of the present disclosure provide an instantaneous heating cup, including:
a cup body, configured with a heating zone and a mixing zone communicating with the heating zone;
a water inlet pipe, connected to the cup body, wherein the water inlet pipe has a water inlet communicating with the heating zone;
a water outlet pipe, connected to the cup body, wherein the water outlet pipe has a water outlet communicating with the mixing zone and the water outlet is arranged to incline towards the mixing zone; and
a heating member, arranged in the heating zone and configured to heat water flowing through the heating zone.

In a second aspect, some embodiments of the present disclosure provide a water heater apparatus, including the above-mentioned instantaneous heating cup.

In the technical solution of some embodiments of the present disclosure, the cup body is configured with the heating zone and the mixing zone therein. The heating member is arranged inside the heating zone. The water inlet of the water inlet pipe is fluidly connected to the heating zone. The water outlet of the water outlet pipe is fluidly connected to the mixing zone.

### BRIEF DESCRIPTION OF THE DRAWINGS

To illustrate the embodiments or the technical solutions in the related art more clearly, a simple introduction of the figures used in some embodiments or descriptions of the related art is provided below. It is evident that the figures described below are only some of the embodiments of the present disclosure, and those skilled in the art can obtain other figures based on these structures without creative effort.

FIG. 1 is a schematic structural view of an embodiment of an instantaneous heating cup in the present disclosure.

FIG. 2 is a front view of the instantaneous heating cup in FIG. 1.

FIG. 3 is a cross-sectional view of the instantaneous heating cup shown in FIG. 2.

FIG. 4 is a schematic structural view of the instantaneous heating cup with some parts of the cup body omitted from FIG. 1.

FIG. 5 is a front view of the instantaneous heating cup shown in FIG. 4.

FIG. 6 is a schematic structural view of an embodiment of a water heater apparatus (with a front cover of a housing removed).

FIG. 7 is a front view of the water heater apparatus in FIG. 6.

FIG. 8 is a block diagram of part of the water heater apparatus in FIG. 6.

### REFERENCE NUMBERS IN THE DRAWINGS

| Reference | | Reference | |
|---|---|---|---|
| No. | Name | No. | Name |
| 10 | Instantaneous | 16 | Water outlet joint |
| | heating cup | | |
| 11 | Cup body | 17 | Heat sink |
| 111 | Heating zone | 20 | Housing |
| 112 | Mixing zone | 201 | First area |
| 12 | Water inlet pipe | 202 | Second area |
| 102 | Water inlet | 203 | Wiring area |
| 13 | Water outlet pipe | 21 | Partition member |
| 103 | Water outlet | 211 | Side baffle |
| 131 | Curved pipe section | 212 | Top baffle |
| 132 | Extended pipe section | 22 | Drain hole |
| 14 | Heating member | 30 | Electrical control |
| | | | component |
| 141 | Wiring terminal | 40 | Terminal board |
| 142 | Heating tube | 50 | Silicon-controlled |
| | | | rectifier (SCR) |
| 1421 | Curved tube body | 60 | Display panel |
| 1422 | Extended tube body | 70 | Temperature limiter |
| 15 | Water inlet joint | 213 | Bottom baffle |
| 121 | Insertion end | 31 | Flow sensor |
| 32 | Inlet water | 33 | Outlet water |
| | temperature sensor | | temperature sensor |
| 2121 | First plate body | 2122 | Second plate body |
| 1420 | Cavity | | |

The realization of the purpose, functional features and advantages of the present disclosure will be further described in conjunction with the embodiments and with reference to the accompanying drawings.

### DETAILED DESCRIPTION

The following will describe the technical solutions in some embodiments of the present disclosure more clearly and completely with reference to the accompanying drawings. It is evident that the described embodiments are only part of the embodiments in the present disclosure, and not all of them. Based on these embodiments, any other embodiments that those skilled in the art can derive without creative labor shall fall within the scope of protection of the present disclosure.

It should be noted that when directional indications (such as up, down, left, right, front, rear, etc.) are mentioned in some embodiments of the present disclosure, these directional indications are only used to explain the relative position or movement between the components in a specific posture. If the posture changes, the directional indications will also be changed accordingly.

Additionally, when the terms “first,” “second,” etc., are used in some embodiments of the present disclosure, they are used only for descriptive purposes and should not be understood as indicating or implying their relative importance or implying the number of the specified technical features. Thus, features with the terms “first” and “second” may explicitly or implicitly include one or more of these features. Moreover, where “and/or” is used throughout the specification, it includes all three combinations of the listed features. Taking “A and/or B” as an example, it includes solution A, solution B, and solutions A and B in combination. Furthermore, the technical solutions described in the various embodiments may be combined with each other by those skilled in the art, unless such a combination would lead to contradiction or infeasibility, in which case the combination shall not be considered as existing, and shall not fall within the scope of protection of the present disclosure.

Some embodiments of the present disclosure provide an instantaneous heating cup 10.

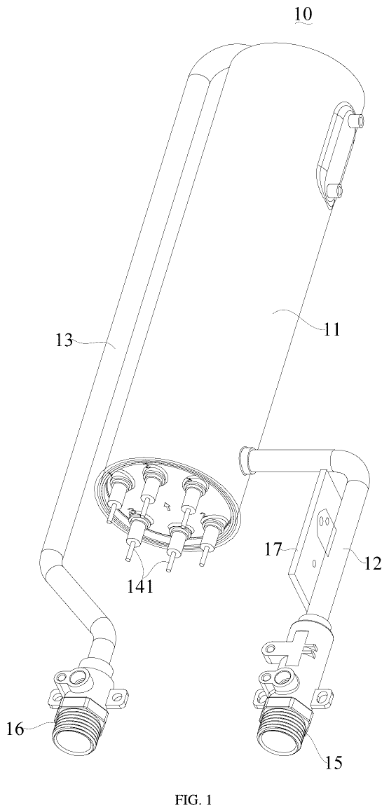

As shown in FIGS. 1 to 5, in some embodiment of the present disclosure, the instantaneous heating cup 10 includes a cup body 11, a water inlet pipe 12, a water outlet pipe 13, and a heating member 14. The cup body 11 is configured with a heating zone 111 and a mixing zone 112 fluidly connected to or communicating with the heating zone 111. The water inlet pipe 12 is connected to the cup body 11 and has a water inlet 102 fluidly connected to or communicating with the heating zone 111. The water inlet pipe 12 is connected to the cup body 11 and has a water inlet 102 fluidly connected to or communicating with the heating zone 111. The water outlet pipe 13 is connected to the cup body 11 and has a water outlet 103 fluidly connected to or communicating with the mixing zone 112. The water outlet 103 is arranged to incline towards the mixing zone 112. For example, the water outlet pipe 13 may have an inclined surface arranged at the water outlet 103. The inclined surface extends from the top of the cup body 11 towards an interior of the mixing zone 112 and away from a centre of the mixing zone 112. The heating member 14 is arranged in the heating zone 111 and is configured to heat the water flowing through the heating zone 111.

In some embodiments, the cup body 11 may be made of stainless steel, and has a slender, hollow cylinder structure, which is conducive to achieving the small volume of the cup body 11. Of course, the cup body 11 may also be designed in other shapes. For example, the cup body 11 may be cylindrical, square, or in other shapes. The present disclosure does not limit this. The cup body 11 may be placed vertically or horizontally, depending on practical needs. The following description primarily uses the cup body 11 placed vertically as an example. Two ends of the cup body 11 are respectively connected to the water inlet pipe 12 and the water outlet pipe 13. The end of the water inlet pipe 12 connected to the cup body 11 is arranged with the water inlet 102, and the end of the water outlet pipe 13 connected to the cup body 11 is arranged with the water outlet 103. To facilitate the connection with external piping, an end of the water inlet pipe 12 away from the water inlet 102 is arranged with a water inlet joint 15. The water inlet joint 15 is configured to be connected to external water supply piping. An end of the water outlet pipe 13 away from the water outlet 103 is arranged with a water outlet joint 16. The water outlet joint 16 is configured to be connected to external water usage piping (such as a showerhead or faucet). In some embodiments, the water inlet joint 15 is welded integrally with the water inlet pipe 12, and the water outlet joint 16 is welded integrally with the water outlet pipe 13. This can simplify the assembly process and reduce the risk of water leakage. The heating zone 111 and the mixing zone 112 are configured inside the cup body 11. The heating zone 111 is arranged with the heating member 14. The heat generated by the heating member 14 may be used to heat the water flowing through the heating zone 111. The mixing zone 112 is configured to mix cold water with hot water. By utilizing the mixing zone 112, the temperature of the hot water which suddenly rises may be adjusted slightly to ensure a constant water temperature at the outlet, reducing the risk of scalding users due to the sudden rise in temperature. When the heating member 14 is in a non-working state that stops heating, the mixing zone 112 may also absorb residual heat from the heating zone 111, which mitigates the issue of the rise of temperature after the water stops flowing. It should be noted that the terms “cold water” and “hot water” here are relative. It may be understood that hot water refers to water heated in the heating zone 111 and having a higher temperature, while cold water refers to the water retained in the mixing zone 112, which is relatively cooler than the hot water.

In the technical solution of some embodiments of the present disclosure, the cup body 11 is configured with the heating zone 111 and the mixing zone 112 therein. The heating member 14 is arranged inside the heating zone 111. The mixing zone 112 is configured with cold water. The water inlet 102 of the water inlet pipe 12 is fluidly connected to the heating zone 111. The water outlet 103 of the water outlet pipe 13 is fluidly connected to the mixing zone 112. In this way, cold water entering the heating zone 111 through the water inlet pipe 12 comes into contact with the heating member 14 to achieve heat exchange. The heated hot water from the heating zone 111 then flows into the mixing zone 112, where it mixes with the cooler water in the mixing zone 112, reducing the temperature of the heated hot water and mitigating the issue of a sudden temperature rise after the water stops flowing, thus ensuring a constant outlet temperature. Additionally, the water outlet 103 is arranged to incline towards the mixing zone 112, facilitating the flow of water into the mixing zone 112 to strike ceaselessly for a more uniform mixing in the mixing zone 112. This further improves the stability of the outlet water temperature, achieving a constant water temperature. The arrangement of the mixing zone 112 also enhances heat transfer between the heating member 14 and the water, which is conducive to conducting enough heat from the heating member 14 to the water, reducing the failure rate of the heating member 14 and extending the service life of the heating member 14. Moreover, the lower surface temperature of the heating member 14 may also reduce residual heat inside the cup body 11 when the water stops, further mitigating the issue of the rise of the temperature after the water stops flowing.

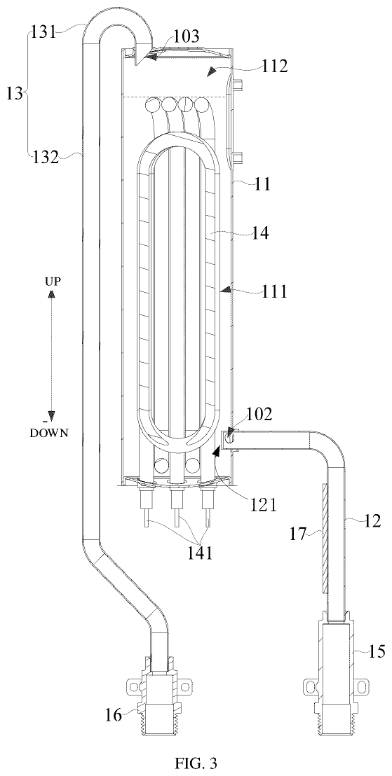

As shown in FIG. 3, in some embodiments, the cup body 11 is arranged to be vertically extended. The vertical direction here refers to the gravity direction. Along the gravity direction, the water inlet pipe 12 is connected to a bottom part of the cup body 11. The water outlet pipe 13 is connected to a top part of the cup body 11. The space between a bottom end of the cup body 11 and a top end of the heating member 14 defines the heating zone 111. The space between the top end of the heating member 14 and a top end of the cup body 11 defines the mixing zone 112.

In some embodiments, the cup body 11 has a hollow cylindrical structure extending vertically. The water inlet pipe 12 is connected to the bottom part of the cup body 11, and the water outlet pipe 13 is connected to the top part of the cup body 11. This allows for water to enter from the bottom part and exit from the top part, which extends the contact time between the water flow and the heating member 14, thereby enabling sufficient heat exchange. The heating member 14 is arranged inside the cup body 11, and the height of the heating member 14 is less than the height of the cup body 11, leaving a certain space between the top end of the heating member 14 and the top end of the cup body 11 to form the mixing zone 112. The space below the mixing zone 112 inside the cup body 11 forms the heating zone 111. In this way, after cold water delivered by the water inlet pipe 12 enters the bottom part of the cup body 11, it rises upwards from the bottom part of the cup body 11 through the heating zone 111 for heating, and finally mixes in the mixing zone 112 at the top part. The water is then discharged through the water outlet 103 arranged to incline, achieving constant temperature water output.

In some embodiments, an end of the water outlet pipe 13 with the water outlet 103 is inserted into the cup body 11 via the top end of the cup body 11, and the water outlet 103 is arranged near an edge of the cup body 11. In this way, the water outlet 103 is arranged away from a center of the mixing zone 112. Since the water outlet 103 is arranged to incline towards the mixing zone 112, the water flow, upon reaching a side of the mixing zone 112, may be directed by an inclined surface or a slanted surface of the water outlet 103 towards the center of the mixing zone 112, resulting in more uniform mixing of the water within the mixing zone 112.

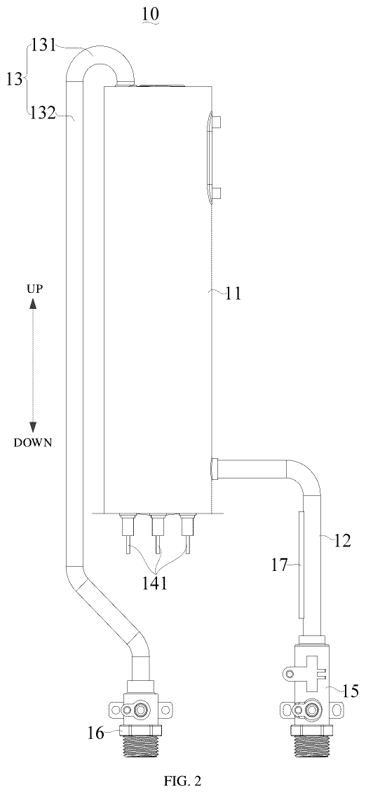

As shown in FIG. 2, in some embodiments, the water outlet pipe 13 includes a curved pipe section 131 and an extended pipe section 132. The curved pipe section 131 and the extended pipe section 132 are fluidly connected to each other. The curved pipe section 131 is arranged above the cup body 11 and bends downward. An end of the curved pipe section 131 is connected to the cup body 11 and is arranged with the water outlet 103. The extended pipe section 132 is connected to the other end of the curved pipe section 131 and is arranged to extend downward. The extended pipe section 132 is substantially linear.

In some embodiments, the water outlet pipe 13 includes the curved pipe section 131 and the extended pipe section 132. The curved pipe section 131 is arranged above the cup body 11 and forms a downward U-shaped structure which is curved downward. That is, the curved pipe section 131 opens downwards. An end of the curved pipe section 131 arranged with the water outlet 103 is inserted into the cup body 11 and fluidly connected to the mixing zone 112. In some embodiments, the curved pipe section 131 is welded integrally with the cup body 11 to reduce the risk of leakage. An end of the extended pipe section 132 is connected to the curved pipe section 131 at an end of the curved pipe section 131 away from the water outlet 103. The other end of the extended pipe section 132 extends downward below the cup body 11. An end of the extended pipe section 132 away from the curved pipe section 131 is arranged with a water outlet joint 16. In some embodiments, the water outlet joint 16 is welded integrally with the extended pipe section 132 to reduce the risk of leakage. After being mixed in the mixing zone 112, the water flows out of the water outlet 103 into the curved pipe section 131 and is then discharged through the extended pipe section 132 to external water pipelines (such as a showerhead or faucet). By designing the curved pipe section 131 with the inverted U-shape and arranging it above the cup body 11, when water flow stops, any residual heat inside the cup body 11 may be concentrated at the very top part of the cup body 11 and dissipated through the curved pipe section 131. This further mitigates the issue of the rise of the temperature after water stops flowing. Additionally, the curved pipe section 131 with the inverted U-shape helps prevent siphoning.

Since the cup body 11 is designed to have a small volume, the distance between the bottom part and top part of the cup body 11 is usually short. After the water enters the bottom part of the cup body 11, it quickly spreads out and outflows directly from the water outlet 103 at the top part in a very short time, resulting in a short residence time for the water inside the cup body 11 and insufficient contact time with the heating member 14, leading to inadequate heat exchange. To further increase the residence time of the water in the cup body 11, as shown in FIG. 3, in some embodiments, the water inlet pipe 12 has an insertion end 121 that is inserted into the cup body 11. An end surface of the insertion end 121 is sealed. A side surface of the insertion end 121 is arranged with the water inlet 102.

It can be understood that heat transfer generally occurs in three basic forms: thermal conduction, thermal radiation, and thermal convection. Since water is not a good conductor of heat, the heating member 14 does not heat the water through thermal conduction. Additionally, since water is transparent and less affected by radiation, the heating member 14 does not heat the water through thermal radiation either. The heating member 14 primarily heats the water through thermal convection. As the water temperature rises, the top part becomes very hot while the bottom part remains relatively cold, with the hot water rising and the cold water staying at the bottom. In some embodiments, the water inlet pipe 12 has the insertion end 121 that is inserted into the cup body 11 from a side of the bottom part. By sealing the end surface of the insertion end 121 and arranging the water inlet 102 on a side of the insertion end 121, the water from the water inlet pipe 12, when enters the cup body 11, may spiral upward along an inner wall of the cup body 11, forming a spiral water channel inside the cup body 11. This slows the rise of the hot water, increases the residence time of the water inside the cup body 11, and expands a surface area and time for thermal convection, allowing for more thorough heat exchange between the water and the heating member 14, effectively carrying away the heat from the surface of the heating member 14. This further enhances heat exchange efficiency and reduces the failure rate of the heating member 14, thereby extending the service life of the heating member 14. The shape of the water inlet 102 may be designed as a round hole, square hole, or other shaped holes. The present disclosure does not limit this.

To further extend the service life of the heating member 14, in some embodiments, a plurality of wiring terminals 141 of the heating member 14 extends through and further out of the bottom surface of the cup body 11. It may be understood that when the instantaneous heating cup 10 adopts a bottom water inlet and top water outlet configuration, the bottom area of the cup body 11 is a cold-water zone. By designing the plurality of wiring terminals 141 of the heating member 14 at the bottom part of the cup body 11, a heat dissipation for the wiring terminal 141 may be improved, which may further reduce the failure rate of the heating member 14 and extend the service life of the heating member 14.

In the related art, the heating member of the instantaneous heating cup typically adopts a spiral-shaped heating tube. That is, the heating tube spirals along an axial direction of the cup body, thus requiring many coil turns. The heating tube usually includes a tube body with a heating wire arranged inside the tube body. The tube body is also filled with magnesium powders. Magnesium powders may easily become loose at an R-angle, also called filleted corner, of a bend of the heating tube. The more R angles there are, the higher the failure rate.

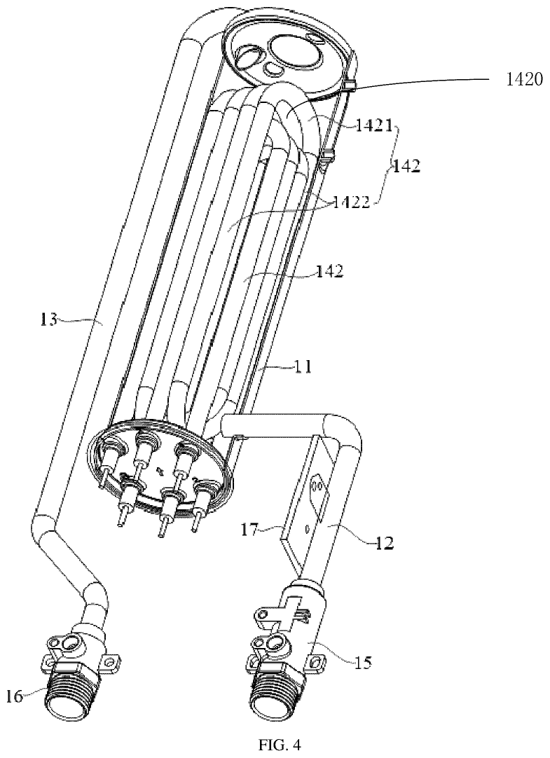

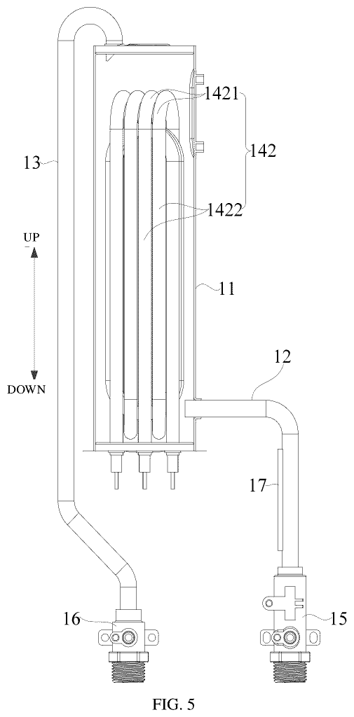

To further reduce the failure rate of the heating member 14, as shown in FIGS. 4 and 5, in some embodiments, the heating member 14 includes the one or more heating tubes 142. Each of the one or more heating tubes 142 includes a curved tube body 1421 and two extended tube bodies 1422 respectively connected to two ends of the curved tube body 1421. The two extended tube bodies 1422 extend substantially parallel to each other along the axial direction of the cup body 11. The two extended tube bodies 1422 are substantially linear. In some embodiments, the heating member 14 includes the one or more heating tubes 142, and the number of the heating tubes 142 may be set as one, two, or more, according to actual needs. The two extended tube bodies 1422 of each of the one or more heating tubes 142 extend substantially parallel to each other along the axial direction of the cup body 11 (i.e., a height direction of the cup body 11). The curved tube body 1421 is connected to the same end of the two extended tube bodies 1422, enabling each of the one or more heating tubes 142 to be arranged in a U-shape or an inverted U-shape. This design reduces the number of the R-angles in each of the one or more heating tubes 142, thereby reducing the looseness of the magnesium powders inside the one or more heating tubes 142, which in turn lowers the failure rate of each of the one or more heating tubes 142, thereby reducing the failure rate of the heating member 14 and extending the service life of the heating member 14.

In some embodiments, the cup body 11 extends vertically. The water inlet pipe 12 is connected to the bottom part of the cup body 11, and the water outlet pipe 13 is connected to the top part of the cup body 11. The space between the bottom end of the cup body 11 and the top end of the heating member 14 defines the heating zone 111, and the space between the top end of the heating member 14 and the top end of the cup body 11 defines the mixing zone 112. The heating member 14 is arranged inside the cup body 11 and extends vertically. Each of the one or more heating tubes 142 of the heating member 14 is arranged in an inverted U-shape. The wiring terminals 141 of each of the one or more heating tubes 142 extends through and further out of the bottom part of the cup body 11. In this way, on the one hand, the inverted U-shape design of each of the one or more heating tubes 142 reduces the number of the R-angles and decreases the looseness of the magnesium powders inside each of the one or more heating tubes 142. On the other hand, by arranging the plurality of wiring terminals 141 of each of the one or more heating tubes 142 at the bottom part of the cup body 11, where the cold water zone is located, the heat dissipation for the plurality of wiring terminals 141 is improved. These combined factors effectively reduce the failure rate of the heating member 14 and extend the service life of the heating member 14.

Furthermore, a plurality of heating tubes 142 are arranged. At least one of the heating tubes 142 is arranged within a cavity 1420 formed by a bend of another one of the heating tubes 142. In some embodiments, the heating member 14 includes a plurality of heating tubes 142. The plurality of heating tubes 142 may be connected in series or parallel to adjust the heating power. Each heating tube 142 is U-shaped and bent to form a cavity 1420. By arranging at least one of the heating tubes 142 within the cavity 1420 formed by the bend of the another one of the heating tubes 142, the space within the cavity 1420 formed by the bend of the another one of the heating tubes 142 may be fully utilized. This allows the plurality of heating tubes 142 to be arranged within a small space, effectively increasing the power density of the heating member 14 and meeting the demand for high-power and rapid heating.

Some embodiments of the present disclosure also provide a water heater apparatus that includes the instantaneous heating cup 10. The instantaneous heating cup 10 includes a cup body 11, a water inlet pipe 12, a water outlet pipe 13, and a heating member 14. The cup body 11 is configured with a heating zone 111 and a mixing zone 112 fluidly connected to or communicating with the heating zone 111. The water inlet pipe 12 is connected to the cup body 11 and has a water inlet 102 fluidly connected to or communicating with the heating zone 111. The water outlet pipe 13 is connected to the cup body 11 and has a water outlet 103 fluidly connected to or communicating with the mixing zone 112. The water outlet 103 is arranged to incline towards the mixing zone 112. The heating member 14 is arranged in the heating zone 111 and is configured to heat the water flowing through the heating zone 111.

The water heater apparatus according to some embodiments of the present disclosure adopts the aforementioned instantaneous heating cup 10. The cup body of the instantaneous heating cup 10 is configured with the heating zone 111 and the mixing zone 112 therein. A heating member 14 is arranged inside the heating zone 111. The water inlet 102 of the water inlet pipe 12 is fluidly connected to the heating zone 111. The water outlet 103 of the water outlet pipe 13 is fluidly connected to the mixing zone 112. In this way, cold water entering the heating zone 111 through the water inlet pipe 12 comes into contact with the heating member 14 to achieve heat exchange. The heated hot water from the heating zone 111 then flows into the mixing zone 112, where it mixes with the cooler water in the mixing zone 112, reducing the temperature of the heated hot water and mitigating the issue of a sudden temperature rise after the water stops flowing, thus ensuring a constant outlet temperature. Additionally, the water outlet 103 is arranged to incline towards the mixing zone 112, facilitating the flow of water into the mixing zone 112 to strike ceaselessly for a more uniform mixing in the mixing zone 112. This further improves the stability of the outlet water temperature, achieving a constant water temperature. The arrangement of the mixing zone 112 also enhances heat transfer between the heating member 14 and the water, which is conducive to conducting enough heat from the heating member 14 to the water, reducing the failure rate of the heating member 14 and extending the service life of the water heater apparatus.

The structure of the instantaneous heating cup 10 may refer to the above-mentioned embodiments. Since the water heater apparatus adopts all the technical solutions from the above-mentioned embodiments, the water heater apparatus at least possesses all the technical effects brought by the technical solutions in the aforementioned embodiments, which will not be repeated here. The water heater apparatus includes, but is not limited to, an instantaneous water heater, an instantaneous water dispenser, an electric wall-mounted boiler, and a smart bathroom appliance.

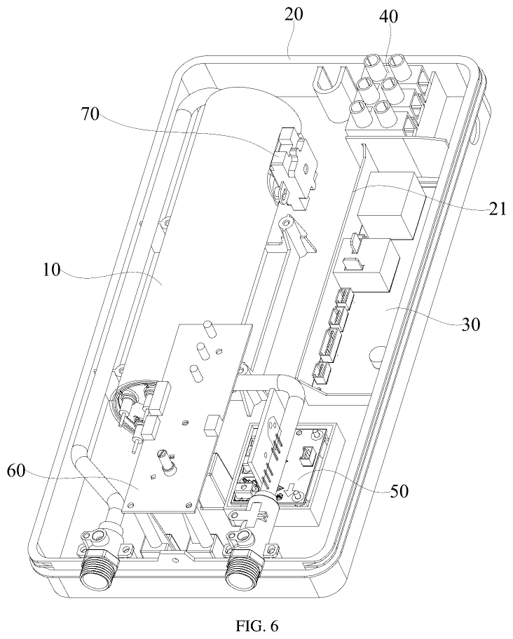

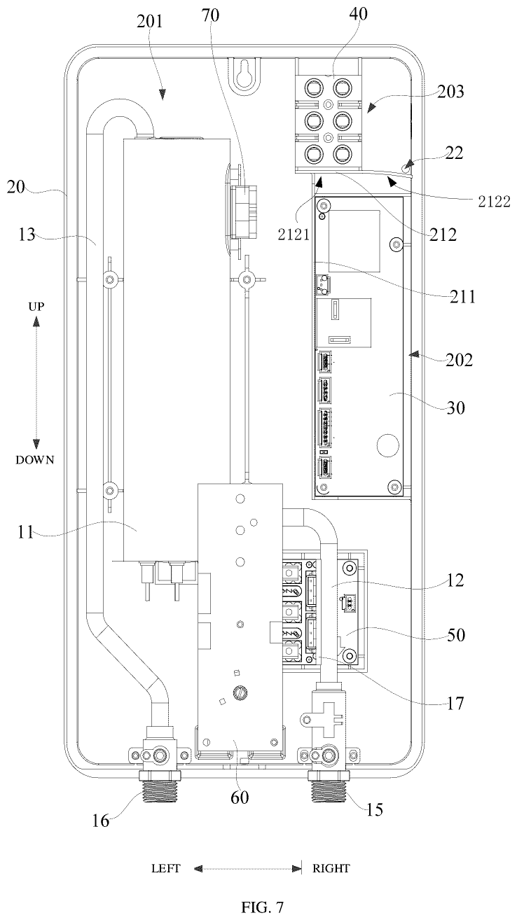

As shown in FIGS. 6 and 7, in some embodiments, the water heater apparatus also includes a housing 20 and an electrical control component 30. The electrical control component 30 is electrically connected to the instantaneous heating cup 10. A partition member 21 is arranged inside the housing 20. The partition member 21 divides an internal cavity of the housing 20 into a first area 201 and a second area 202. The instantaneous heating cup 10 is arranged in the first area 201, and the electrical control component 30 is arranged in the second area 202.

In some embodiments, the housing 20 includes a bottom shell and a front cover engaged with each other. The enclosed space between the bottom shell and the front cover forms an installation cavity configured to install the instantaneous heating cup 10 and the electrical control component 30. To show the internal structure of the water heater apparatus clearly, the water heater apparatus shown in FIGS. 6 and 7 has the front cover of the housing 20 removed. Both the instantaneous heating cup 10 and the electrical control component 30 are installed or mounted on the bottom shell of the housing 20. In some embodiments, at least one mounting hole may be defined at the bottom shell for securing the bottom shell to a wall. The electrical control component 30 may include main a control board, a power supply, and other electrical elements. The partition member 21 is arranged in the housing 20. The partition member 21 may be integrally formed with the housing 20, or the partition member 21 may be assembled to the housing 20 by screws, snap-fit connections, or other methods. In some embodiments, the partition member 21 is integrally formed with the housing 20. For example, in some embodiments, the partition member 21 is integrally formed on an inner side surface of the bottom shell, which may simplify the manufacturing process and effectively reduce any sealing issues between the partition member 21 and the bottom shell, and further reduce the issue of water flowing into the second area through gaps between the partition member 21 and the bottom shell.

In some embodiments, the partition member 21 divides the internal cavity of the housing 20 into the first area 201 and the second area 202. The first area 201 and the second area 202 are separated from each other. The instantaneous heating cup 10 is arranged in the first area 201, and the electrical control component 30 is arranged in the second area 202. In this way, the water circuit component and the electrical circuit component of the water heater apparatus are separated from each other, reducing the occurrence of water splashing onto the electrical circuit component in the event of a malfunction in the instantaneous heating cup 10, thus reducing electrical leakage or short circuits. This may effectively improve the safety of the water heater apparatus.

As shown in FIG. 7, in some embodiments, the housing 20 also includes a wiring area 203. The water heater apparatus further includes a terminal board 40 arranged in the wiring area 203. The housing 20 is defined with a drain hole 22 configured to communicate the wiring area 203 with the outside.

In some embodiments, the wiring area 203 arranged inside the housing 20 facilitates the installation of the terminal board 40, allowing for the connection of a power line via the terminal board 40. An incoming line terminal of the power line is inserted in the terminal board 40. In some environments, condensation formed on the surface of the power line may drip into the wiring area 203. By defining the drain hole 22 on the housing 20, the condensation inside the wiring area 203 may be drained, reducing electrical leakage and short circuits, thereby further enhancing the safety of the water heater apparatus.

Furthermore, the first area 201 and the second area 202 are arranged side by side along a horizontal direction, with the wiring area 203 arranged above the second area 202. The horizontal direction here refers to a direction perpendicular to the gravity direction. The partition member 21 includes a side baffle 211 arranged between the first area 201 and the second area 202, and a top baffle 212 arranged between the wiring area 203 and the second area 202. The top baffle 212 is configured to guide water in the wiring area 203 towards the drain hole 22.

In some embodiments, the first area 201 and the second area 202 are arranged side by side along the horizontal direction, with the wiring area 203 arranged above the first area 201, creating a compact layout. In some embodiments, the first area 201 may be arranged on a left or right side of the second area 202. For example, the first area 201 is arranged on the left side of the second area 202, with the instantaneous heating cup 10 arranged on the left side of the housing 20 and the electrical control component 30 (such as the main control board, power supply, etc.) arranged on the right side of the housing 20. The side baffle 211 of the partition member 21 separates the two areas, achieving a water-electricity separation, which is also easy to maintain. The wiring area 203 is arranged above the second area 202, enabling the terminal board 40 to be arranged above the electrical control component 30, making it convenient for connecting the power lines. The terminal board 40 is separated from the electrical control component 30 by the top baffle 212 of the partition member 21. After any condensation from the power line connected to the terminal board 40 drips onto the top baffle 212, the condensation may be guided towards the drain hole 22 for rapid drainage. In some embodiments, the partition member 21 also includes a bottom baffle 213 arranged opposite to the top baffle 212 and spaced apart from the top baffle 212. The bottom baffle 213 is arranged at an end of the side baffle 211 away from the top baffle 212. A side of the top baffle 212 away from the side baffle 211, and a side of the bottom baffle 213 away from the side baffle 211 are connected to the side wall of the housing 20, thereby forming a relatively enclosed second area 202 surrounded by the partition member 21 and the side wall of the housing 20. The electrical control component 30 is arranged within the enclosed area. The partition member 21 is arranged around the outer periphery of the electrical control component 30, providing better protection for the electrical control component 30.

Furthermore, as shown in FIG. 7, the top baffle 212 includes a first plate body 2121 arranged at the bottom of the terminal board 40 and a second plate body 2122 extending from a side of the first plate body 2121 to the side of the housing 20. The second plate body 2122 is arranged to incline downward relative to the first plate body 2121, and the drain hole 22 is arranged on a side of the second plate 2122 body away from the first plate body 2121.

In some embodiments, the first plate body 2121 is arranged at the bottom of the terminal board 40, providing support and limitation for the terminal board 40. The second plate body 2122 is arranged to incline downward relative to the first plate body 2121. A side of the second plate body 2122 away from the first plate body 2121 is relatively lower than a side of the second plate body 2122 close to the first plate body 2121. The drain hole 22 is defined on a side of the second plate body 2122 away from the first plate body 2121. The condensation dripping onto the top baffle 212 may quickly flow down the sloped surface of the second plate body 2122 and into the drain hole 22. This design facilitates the rapid drainage of condensation.

As shown in FIG. 7, in some embodiments, the water heater apparatus also includes a silicon-controlled rectifier (SCR) 50 arranged inside the housing 20. The SCR 50 is electrically connected to the electrical control component 30. The SCR 50 is configured to adjust the heating power of the heating member 14 based on a control signal from the electrical control component 30. A heat sink 17 is arranged on an exterior of the water inlet pipe 12, and the SCR 50 is in contact with the heat sink 17.

In some embodiments, the heating power of the heating member 14 may be adjusted by the SCR 50. The SCR 50 generates heat during operation, and to dissipate this heat, the heat sink 17 is arranged on the exterior of the water inlet pipe 12, and the SCR 50 is in contact with the heat sink 17. Since the water flow inside the water inlet pipe 12 has a relatively low temperature, the heat sink 17 may transfer the low temperature to the SCR 50 for cooling, thereby reducing the failure rate of the SCR 50 and extending the service life of the SCR 50. The heat sink 17 may be assembled integrally to the water inlet pipe 12 through welding or fastening connections. In some embodiments, the SCR 50 and the heat sink 17 may be designed as an integrated module, which may be easily mounted onto the exterior of the water inlet pipe 12 with fasteners when needed.

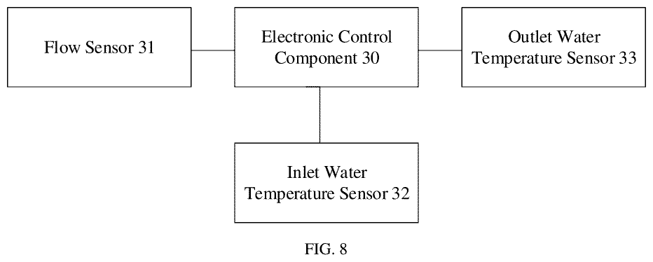

Building on the previous embodiments, as shown in FIG. 8, in some embodiments, the water heater apparatus further includes a flow sensor 31, an inlet water temperature sensor 32, and an outlet water temperature sensor 33, all of which are electrically connected to the electrical control component 30. The flow sensor 31 and the inlet water temperature sensor 32 are arranged on the water inlet pipe 12, while the outlet water temperature sensor 33 is arranged on the water outlet pipe 13. The electrical control component 30 is configured to control the heating power of the heating member 14 based on a detect signal from the flow sensor 31, the inlet water temperature sensor 32, and the outlet water temperature sensor 33.

In some embodiments, the flow sensor 31 is configured to detect the water flow rate. The inlet water temperature sensor 32 is configured to detect the inlet water temperature. The outlet water temperature sensor 33 is configured to detect the outlet water temperature. Cold water is delivered into the cup body 11 through the water inlet pipe 12. Once the flow sensor 31 arranged on the water inlet pipe 12 detects a flow signal, for example, when the flow sensor 31 detects that the water flow rate reaches 1.5 L/min, the electrical control component 30 activates the water heater apparatus based on the flow signal from the flow sensor 31. The electrical control component 30 is configured to receive a detect signal from the flow sensor 31, the inlet water temperature sensor 32, and the outlet water temperature sensor 33. By using the control chip in the electrical control component 30, the required power may be calculated. The electrical control component 30 then sends a control signal to control the heating power of the heating member 14. For example, in some embodiments, the water heater apparatus includes the SCR 50 electrically connected to the electrical control component 30. The control chip in the electrical control component 30 calculates the required heating power and sends the control signal to the SCR 50. The SCR 50 may further adjust the heating power of the heating member 14 to meet user demands. In this way, intelligent control of the water heater apparatus is achieved, allowing the water heater apparatus to quickly adjust the heating member 14 to the required power after activation, thereby enabling rapid heating.

In some embodiments, the water heater apparatus also includes a display panel 60, and the display panel 60 may be configured to display an operating status of the water heater apparatus (e.g., water temperature, heating time, etc.), allowing the user to monitor the operating status of the water heater apparatus in real-time. Meanwhile, the user may also control the water heater apparatus via control buttons on the display panel 60. In some embodiments, the water heater apparatus further includes a temperature limiter 70 arranged on the exterior of the cup body 11. The temperature inside the cup body 11 may be controlled by the temperature limiter 70.

The above descriptions are merely some embodiments of the present disclosure and do not limit the scope of the present disclosure. Any equivalent structural transformations made under the inventive concept of the present disclosure, or direct or indirect applications in other related technical fields, shall fall within the scope of protection of the present disclosure.

What is claimed is:

1. An instantaneous heating cup, comprising:
a cup body, configured with a heating zone and a mixing zone communicating with the heating zone;
a water inlet pipe, connected to the cup body, wherein the water inlet pipe has a water inlet communicating with the heating zone;
a water outlet pipe, connected to the cup body, wherein the water outlet pipe has a water outlet communicating with the mixing zone and the water outlet is arranged to incline towards the mixing zone; and
a heating member, arranged in the heating zone and configured to heat water flowing through the heating zone.

2. The instantaneous heating cup as claimed in claim 1, wherein the cup body extends vertically, the water inlet pipe is connected to a bottom part of the cup body, and the water outlet pipe is connected to a top part of the cup body, the space between a bottom end of the cup body and a top end of the heating member defines the heating zone, and the space between the top end of the heating member and a top end of the cup body defines the mixing zone.

3. The instantaneous heating cup as claimed in claim 1, wherein an end of the water outlet pipe with the water outlet is inserted into the top end of the cup body, and the water outlet is arranged near an edge of the cup body.

4. The instantaneous heating cup as claimed in claim 1, wherein the water outlet pipe comprises a curved pipe section and an extended pipe section communicating with each other, the curved pipe section is arranged above the cup body and bends downward, an end of the curved pipe section is connected to the cup body and is arranged with the water outlet, and the extended pipe section is connected to the other end of the curved pipe section and extends downward.

5. The instantaneous heating cup as claimed in claim 1, wherein the water inlet pipe has an insertion end inserted into the cup body, an end surface of the insertion end is sealed, and the water inlet is arranged on a side surface of the insertion end.

6. The instantaneous heating cup as claimed in claim 1, wherein the heating member comprises a plurality of wiring terminals extending through and further out of a bottom surface of the cup body.

7. The instantaneous heating cup as claimed in claim 1, wherein the heating member comprises one or more heating tubes, each of the one or more heating tubes comprises a curved tube body and two extended tube bodies, two ends of the curved tube body are connected respectively to the two extended tube bodies, and the two extended tube bodies extend substantially parallel to each other along an axial direction of the cup body.

8. The instantaneous heating cup as claimed in claim 7, wherein the heating member comprises a plurality of heating tubes, at least one of the plurality of heating tubes is arranged within a cavity formed by a bend of another one of the plurality of heating tubes.

9. A water heater apparatus, comprising:
an instantaneous heating cup, comprising:
a cup body, configured with a heating zone and a mixing zone communicating with the heating zone;
a water inlet pipe, connected to the cup body, wherein the water inlet pipe has a water inlet communicating with the heating zone;
a water outlet pipe, connected to the cup body, wherein the water outlet pipe has a water outlet communicating with the mixing zone and the water outlet is arranged to incline towards the mixing zone; and
a heating member, arranged in the heating zone and configured to heat water flowing through the heating zone.

10. The water heater apparatus as claimed in claim 9, wherein the cup body extends vertically, the water inlet pipe is connected to a bottom part of the cup body, and the water outlet pipe is connected to a top part of the cup body, the space between a bottom end of the cup body and a top end of the heating member defines the heating zone, and the space between the top end of the heating member and a top end of the cup body defines the mixing zone.

11. The water heater apparatus as claimed in claim 9, wherein an end of the water outlet pipe with the water outlet is inserted into the top end of the cup body, and the water outlet is arranged near an edge of the cup body.

12. The water heater apparatus as claimed in claim 9, wherein the water outlet pipe comprises a curved pipe section and an extended pipe section communicating with each other, the curved pipe section is arranged above the cup body and bends downward, an end of the curved pipe section is connected to the cup body and is arranged with the water outlet, and the extended pipe section is connected to the other end of the curved pipe section and extends downward.

13. The water heater apparatus as claimed in claim 9, wherein the water inlet pipe has an insertion end inserted into the cup body, an end surface of the insertion end is sealed, and the water inlet is arranged on a side surface of the insertion end.

14. The water heater apparatus as claimed in claim 9, wherein the heating member comprises a plurality of wiring terminals extending through and further out of a bottom surface of the cup body.

15. The water heater apparatus as claimed in claim 9, further a housing and an electrical control component, wherein the electrical control component is electrically connected to the instantaneous heating cup, the housing is arranged with a partition member, the partition member divides an interior cavity of the housing into a first area and a second area, the instantaneous heating cup is arranged in the first area, and the electrical control component is arranged in the second area.

16. The water heater apparatus as claimed in claim 15, wherein the housing further comprises a wiring area, the water heater apparatus further comprises a terminal board arranged in the wiring area, the housing is defined with a drain hole, and the drain hole is configured to communicate the wiring area with the exterior.

17. The water heater apparatus as claimed in claim 16, wherein the first area and the second area are arranged side by side along a horizontal direction, the wiring area is arranged above the second area, the partition member comprises a side baffle and a top baffle, the side baffle is arranged between the first area and the second area, and the top baffle is arranged between the wiring area and the second area and configured to guide water in the wiring area towards the drain hole.

18. The water heater apparatus as claimed in claim 16, wherein the top baffle comprises a first plate body arranged at a bottom part of the terminal board and a second plate body extending from a side of the first plate body to a side of the housing, the second plate is arranged to incline downward relative to the first plate body, and the drain hole is arranged on a side of the second plate body away from the first plate body.

19. The water heater apparatus as claimed in claim 16, wherein the water heater apparatus further comprises an SCR (Silicon-Controlled Rectifier) arranged inside the housing, the SCR is electrically connected to the electrical control component and is configured to adjust a heating power of the heating member based on a control signal from the electrical control component, a heat sink is arranged on an exterior of the water inlet pipe, and the SCR is in contact with the heat sink.

20. The water heater apparatus as claimed in claim 16, wherein the water heater apparatus further comprises a flow sensor, an inlet water temperature sensor, and an outlet water temperature sensor, the flow sensor, the inlet water temperature sensor, and the outlet water temperature sensor are all electrically connected to the electrical control component, the flow sensor and the inlet water temperature sensor are arranged on the water inlet pipe, the outlet water temperature sensor is arranged on the water outlet pipe, the electrical control component is configured to control the heating power of the heating member based on a detect signal from the flow sensor, the inlet water temperature sensor, and the outlet water temperature sensor.
